(19) United States
(12) Patent Application Publication
(10) Pub. No.: US 2024/0029501 A1
(43) Pub. Date: Jan. 25, 2024

(54) GRAPHICAL USER INTERFACE FOR ANIMATING USER DATA

(71) Applicant: Gravystack, Inc., Phoenix, AZ (US)

(72) Inventors: Scott Donnell, Phoenix, AZ (US); Travis Adams, Phoenix, AZ (US); Chad Willardson, Phoenix, AZ (US)

(73) Assignee: Gravystack, Inc., Phoenix, AZ (US)

(21) Appl. No.: 17/872,099

(22) Filed: Jul. 25, 2022

(51) Int. Cl. G07F 17/32

(52) U.S. Cl. CPC G07F 17/3213; G07F 17/3251

(57) ABSTRACT

In an aspect, an apparatus for generating a graphical user interface (GUI) for animating user data is presented. The GUI includes a first set of pictorial icons. Each pictorial icon of a first set of pictorial icons includes a symbolic category. The GUI includes a second set of pictorial icons. Each pictorial icon of a second set of pictorial icons includes a distribution category. The GUI includes an interactive icon configured to receive user input. The GUI is configured to animate an interactive icon from a first position to a second position. The GUI is configured to animate a flow graphic from at least a pictorial icon from a first set of pictorial icons to at least a pictorial icon from a seconds et of pictorial icons.

### FIELD OF THE INVENTION

The present invention generally relates to the field of graphical user interfaces. In particular, the present invention is directed to a graphical user interface for animating user data.

### BACKGROUND

Modern presentations of data through graphical user interfaces can be clunky and unintriguing. As such, modern graphical user interfaces can be improved.

### SUMMARY OF THE DISCLOSURE

In an aspect, an apparatus for generating a graphical user interface (GUI) for animating user data includes at least a processor and a memory communicatively connected to the at least a processor. The memory contains instructions configuring at least a processor to generate a GUI. A GUI includes a first set of pictorial icons. Each pictorial icon of a first set of pictorial icons includes a symbolic category. A GUI includes a second set of pictorial icons. Each pictorial icon of a second set of pictorial icons includes a distribution category. A GUI includes an interactive icon configured to receive user input. A GUI is configured to animate an interactive icon from a first position to a second position. A GUI is configured to animate a flow graphic from at least a pictorial icon from a first set of pictorial icons to at least a pictorial icon from a second set of pictorial icons.

In another aspect, a method of animating user data through a computing device is presented. A method includes displaying a first set of pictorial icons through a graphical user interface. A method includes displaying a second set of pictorial icons through a graphical user interface. A method includes displaying an interactive icon configured to receive user input through a graphical user interface. A method includes animating an interactive icon from a first position to a second position. A method includes animating a flow graphic from at least a pictorial icon from a first set of pictorial icons to at least a pictorial icon from a second set of pictorial icons.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for generating a GUI;

FIG. 2 is an illustration of an exemplary embodiment of a GUI;

FIG. 3 illustrates particular, exemplary implementations of interacting with a GUI;

FIG. 4 is an illustration of an exemplary embodiment of a user database;

FIG. 5 is a block diagram of an embodiment of an exemplary embodiment of a machine learning model;

FIG. 6 is a flow diagram of an exemplary method of animating user data; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods of animating user data. In an embodiment, animating user data may include presenting a graphical user interface with an interactive icon responsive to user input.

Aspects of the present disclosure can be used to visualize classifications of user data to one or more categories. Aspects of the present disclosure can also be used to present patterns of user data through a graphical user interface. This is so, at least in part, because animating user data may include animating representations of user data to one or more icons representative of categories of user data.

Aspects of the present disclosure allow for engaging animation of user data. Exemplary embodiments illustrating aspects of the present disclosure are described below in the context of several specific examples.

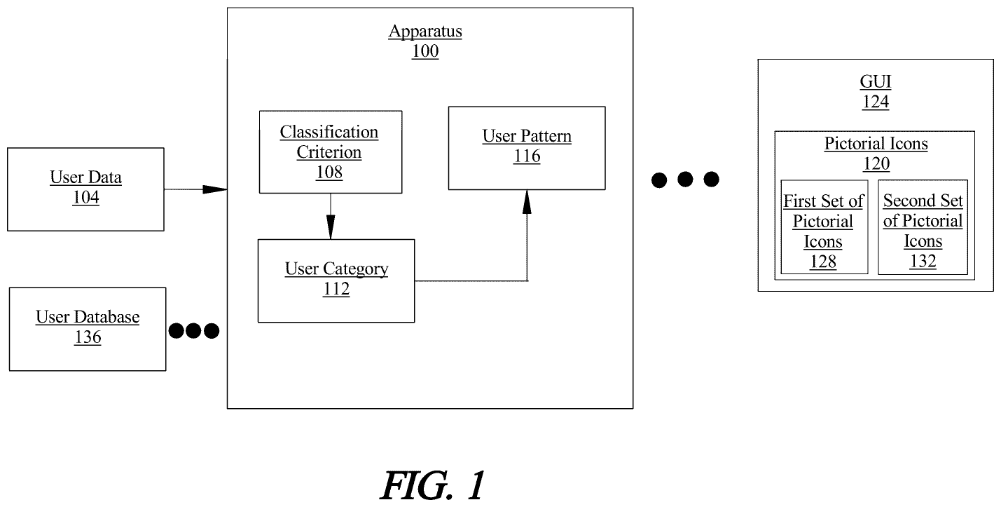

Referring now to FIG. 1, an exemplary embodiment of an apparatus 100 for displaying financial data is presented. Apparatus 100 may include at least a processor and a memory communicatively connected to the at least a processor. A memory may contain instructions configuring the at least a processor to perform various tasks. Apparatus 100 may include a computing device. A computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. Apparatus 100 may include a single computing device operating independently, or may include two or more computing device operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting apparatus 100 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Apparatus 100 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices.

With continued reference to FIG. 1, apparatus 100 may be designed and/or configured to perform any method, method step, or sequence of method steps in any embodiment described in this disclosure, in any order and with any degree of repetition. For instance, apparatus 100 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Apparatus 100 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, apparatus 100 may be configured to receive user data 104. “User data” as used in this disclosure is information pertaining to an individual. Information may include, but is not limited to, employment information, hobby information, health information, and the like. User data 104 may include, without limitation, authentication credentials, user profiles, and the like. User profiles may include, without limitation, geographical data, demographic data, employment data, family data, and the like. Apparatus 100 may generate one or more user profiles as a function of user data 104. In some embodiments, user data 104 may include financial data. “Financial data” as used in this disclosure is information relating to currency. Financial data may include, without limitation, currency amounts, currency transfers, income, bills, and the like. In some embodiments, financial data may be generated through apparatus 100. Apparatus 100 may generate financial data through tracking and/or comparing user data 104 over a period of time, such as, without limitation, minutes, hours, days, weeks, months, years, and the like. In other embodiments, financial data may be received from an external computing device, such as, without limitation, a server, desktop, laptop, cloud-computing network, and the like. User data 104 may be received through a financial database. A “financial database” as used in this discourse is a collection of stored user data relating to currency. A financial database may include, without limitation, mobile applications, banking accounts, crypto wallets, and the like. Apparatus 100 may be in communication with one or more forms of user input interfaces. User input interfaces may include, but are not limited to, web portals, mobile applications, and the like. In some embodiments, apparatus 100 may generate a financial database as a function of user input received from one or more user input interfaces, such as, but not limited to, input received through web portals, mobile applications, and the like. “User input” as used in this disclosure is information received from an individual. User input may include, for instance and without limitation, information entered via text fields, information entered via clicking on icons of a graphical user interface (GUI), information entered via touch input received through one or more touch screens, and the like.

Still referring to FIG. 1, financial data of user data 104 may include one or more currency distributions between two or more entities. A “currency distribution” as used in this disclosure is a transfer of financial value. A currency distribution may include a transfer of currency such as, but not limited to, a transfer between an individual's finance accounts and/or a transfer between an individual's finance accounts and an external finance account. Finance accounts may include, without limitation, banking accounts, credit card services, savings accounts, and the like. In some embodiments, financial data may include distribution quantities, which may include values of one or more transfers between two or more finance accounts. A “distribution quantity” as used in this disclosure is a value of a transfer of between two or more entities. As a non-limiting example, a transfer of currency from Joe's checking account to Joe's credit card company may have a distribution quantity of $40.12. In some embodiments, a distribution quantity may include a total distribution quantity of one or more user categories. A “user category” as used in this disclosure is a classification of user data to one or more groups. User categories may include, but are not limited to, food, entertainment, shopping, automobiles, housing, rent, paying friends and/or family, and the like thereof. In some embodiments, apparatus 100 may input user data 104 and output finance data of user data 104 to one or more user categories. In some embodiments, apparatus 100 may compare user data 104 to classification criterion 108. A “classification criterion” as used in this disclosure is a metric constraining a categorization of data. Classification criterion 108 may include, without limitation, currency distribution types, finance account types, and the like. Currency distribution types may include, but are not limited to, transfers to a savings account, transfers to an individual's friends and/or family, transfers to an individual from an external finance account, and the like. Apparatus 100 may determine user category 112 as a function of a comparison of user data 104 with classification criterion 108. In some embodiments, apparatus 100 may utilize a user category classification model, which may include any type of classifier as described in this disclosure. A user category classification model may be trained with training data correlating currency distributions to user categories. Training data may be received through user input, external computing devices, and/or previous iteration of processing. A user category classification model may be configured to input user data 104 and output one or more user categories and/or subcategories, such as, without limitation, overdraft fees, rent, pet supplies, groceries, and the like.

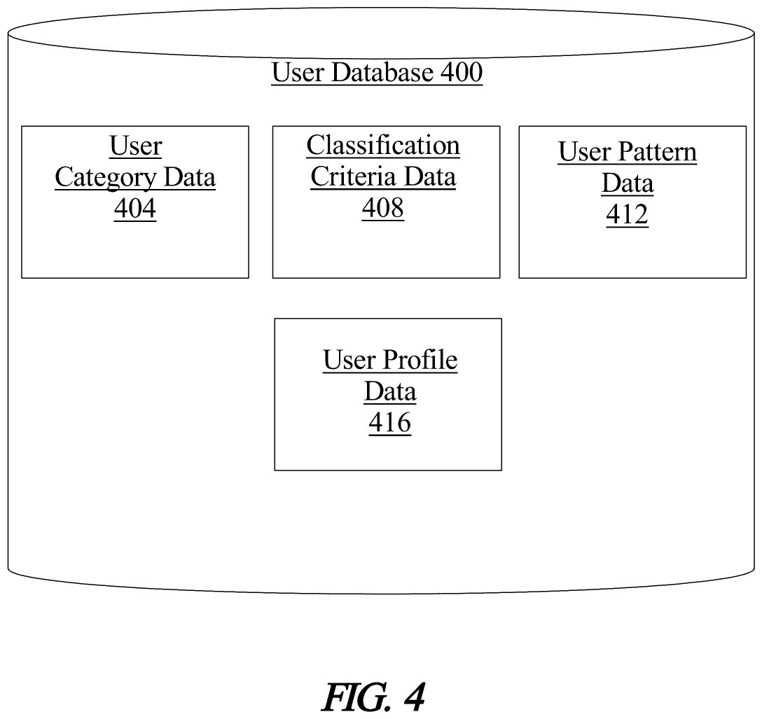

Still referring to FIG. 1, in some embodiments, apparatus 100 may be configured to determine user pattern 116. A “user pattern” as used in this disclosure is a relationship between user data and one or more user categories. User pattern 116 may include, without limitation, trends of one or more currency distributions, average quantities of currency distributions, frequencies of currency distribution types, and the like. For instance and without limitation, user pattern 116 may show 40% of a total value of currency was spent, 10% of a total value of currency was shared, and 50% of a total value of currency was saved. In some embodiments, apparatus 100 may utilize a user pattern machine learning model. A user pattern machine learning model may be trained with training data correlating user data to one or more user patterns. Training data may be received through user input, external computing devices, and/or previous iterations of processing. In some embodiments, a user pattern machine learning model may be configured to input user data 104 and/or classification criterion 108 and output user pattern 116. In some embodiments, apparatus 100 may receive user data 104 through user database 136. A “user database” as used in this disclosure is a collection of information of an individual. User database 136 may be as described below with reference to FIG. 4.

Still referring to FIG. 1, in some embodiments, apparatus 100 may determine one or more pictorial icons 120 as a function of user pattern 116. A “pictorial icon” as used in this disclosure is a graphic illustration displayed on a screen, where the graphic illustration is representative of a category. A “category” as used in this disclosure is a classification of one or more elements to one or more groups. A category may include, but is not limited to, user goals, excess value quantifiers received, custom objectives, and the like. A “value quantifier” as used in this disclosure is a metric assigning an amount of worth to one or more objects, actions, and the like. A value quantifier may include, but is not limited to, number values, currency amounts, and the like. Pictorial icons 120 may include, but are not limited to, dartboards, moneybags, dollar signs, coins, and the like. In some embodiments, pictorial icons 120 may include first set of pictorial icons 128 and/or second set of pictorial icons 132. First set of pictorial icons 128 may include two or more pictorial icons. In some embodiments, first set of pictorial icons 128 may include a category, such as, without limitation, value quantifiers received. A value quantifiers received category may include one or more subcategories, such as, but not limited to, value quantifiers received from user goals, value quantifiers received from custom objectives, and/or excess value quantifiers received. In some embodiments, each pictorial icon of first set of pictorial icons 128 may include a category differing from one or more other pictorial icons of first set of pictorial icons 128. For instance and without limitation, a first pictorial icon of first set of pictorial icons 128 may include a user objective category, a second pictorial icon of first set of pictorial icons 128 may include a custom objective category, and a third pictorial icon of first set of pictorial icons 128 may include an excess value quantifier received category. In some embodiments, second set of pictorial icons 132 may include two or more pictorial icons. Second set of pictorial icons 132 may include a category, such as, without limitation, dispersion of value quantifiers. A dispersion of value quantifiers category may include one or more subcategories, such as, but not limited to, value quantifiers stored, value quantifiers exchanged, and/or value quantifiers shared. In some embodiments, each pictorial icon of second set of pictorial icons 132 may include a category differing from one or more other pictorial icons of second set of pictorial icons 128. For instance and without limitation, a first pictorial icon of second set of pictorial icons 132 may include a value quantifier storage category, a second pictorial icon of second set of pictorial icons 132 may include a value quantifier exchanged category, and a third pictorial icon of second set of pictorial icons 132 may include a value quantifiers shared category.

Still referring to FIG. 1, in some embodiments, apparatus 100 may display pictorial icons 120 through graphical user interface (GUI) 124. A “graphical user interface” as used in this disclosure is an interface including a set of one or more pictorial and/or graphical icons corresponding to one or more computer actions. GUI 124 may be configured to receive user input, as described above. GUI 124 may include one or more event handlers. An “event handler” as used in this disclosure is a callback routine that operates asynchronously once an event takes place. Event handlers may include, without limitation, one or more programs to perform one or more actions based on user input, such as generating pop-up windows, submitting forms, changing background colors of a webpage, and the like. Event handlers may be programmed for specific user input, such as, but not limited to, mouse clicks, mouse hovering, touchscreen input, keystrokes, and the like. For instance and without limitation, an event handler may be programmed to generate a pop-up window if a user double clicks on a specific icon. User input may include, a manipulation of computer icons, such as, but not limited to, clicking, selecting, dragging and dropping, scrolling, and the like. In some embodiments, user input may include an entry of characters and/or symbols in a user input field. A “user input field” as used in this disclosure is a portion of a graphical user interface configured to receive data from an individual. A user input field may include, but is not limited to, text boxes, search fields, filtering fields, and the like. In some embodiments, user input may include touch input. Touch input may include, but is not limited to, single taps, double taps, triple taps, long presses, swiping gestures, and the like. One of ordinary skill in the art will appreciate the various ways a user may interact with graphical user interface 124.

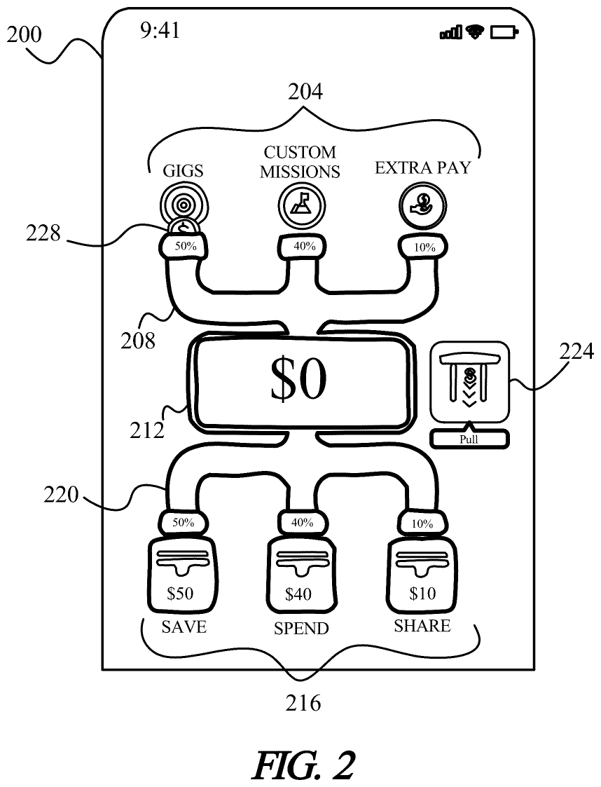

Referring now to FIG. 2, GUI 124 is shown. GUI 124 may be configured to display first set of pictorial icons 204. First set of pictorial icons 204 may include two or more icons. In some embodiments, first set of pictorial icons 204 may include three pictorial icons. First set of pictorial icons may be displayed on GUI 124 at a top portion of GUI 124. First set of pictorial icons 204 may include a shape, such as, but not limited to, circular, rectangular, square, and the like. In some embodiments, each icon of first set of pictorial icons 204 may have a same shape, such as a circle. In other embodiments, each icon of first set of pictorial icons 204 may have differing shapes, for instance and without limitation, a circle, triangle, and/or square. In some embodiments, an allocation box of each icon of first set of pictorial icons 204 may be displayed adjacent to and/or underneath each icon of first set of pictorial icons 204. An “allocation box” as used in this disclosure is a text box representative of a portion of a summate value. A “text box” as used in this disclosure is a field of a GUI programmed to receive semantic data. Semantic data may include, but is not limited to, characters, symbols, phrases, and the like. A “summate value” as used in this disclosure is a cumulative value of one or more quantitative and/or numerically represented elements. For instance and without limitation, an allocation box may include a value of “10”, “5%”, “½”, and the like. Allocation box values may be generated through apparatus 100. In some embodiments, each value of each allocation box of first set of pictorial icons 204 may add up to a whole value, such as, but not limited to, 1, 100, 100%, $50, and the like. In some embodiments, each icon of first set of pictorial icons 204 may include a border. A “border” as used in this disclosure is an outlining of a shape. A border may outline regular shapes, such as, but not limited to, circles, triangles, squares, rectangles, and the like. In some embodiments, a border may outline irregular shapes, such as, but not limited to, irregular pentagons, irregular hexagons, irregular heptagons, and the like. A border may include one or more layers. For instance and without limitation, a border may include a first thin line layer, a second thick colored layer, and a third thin line layer encompassing the first two layers. In some embodiments, a colored layer of a border may have two or more shades of colors, two or more colors, and the like. A colored layer of a border may be representative of a value out of a whole number of an allocation box associated with an icon of first set of pictorial icons 204. For instance and without limitation, a border of a first icon of first set of pictorial icons may include a circle having a dark green layer representative of a portion of a whole number and a light green layer representative of a difference in the whole number and the portion of the whole number. Furthering this example, a circular border of an icon include a first dark green color making up about 60% of the circle, and a light green color making up about 40% of the circle, which may be representative of an allocation box of a first icon having a value of 60%.

Still referring to FIG. 2, in some embodiments, first set of pictorial icons 204 may include one or more symbolic categories. A “symbolic category” as used in this disclosure is a classification of an illustration to a group. A “classification” as used throughout this disclosure is an assigning of one or more elements to one or more groups. An “illustration” as used in this disclosure is a pictorial embodiment of one or more elements. A symbolic category may include, without limitation, gigs, custom missions, extra pay, and the like. A “gig” as used throughout this disclosure is an activity an individual engages in. A gig may include, but is not limited to, walking a dog, house chores, completing a study book, and the like. In some embodiments, a gig may include a job such as, but not limited to, babysitting, cooking, tutoring, and the like. “Custom missions” as used throughout this disclosure are objectives for an individual to complete differing from that of one or more gigs. Custom missions may include, but are not limited to, learning a language, practicing a sport, and the like. “Extra pay” as used throughout this disclosure is currency received differing from gigs and/or custom missions. Extra pay may include, but is not limited to, tips, allowances, and the like. Ins some embodiments, symbolic categories may be generated through apparatus 100 based on user data 104. For instance and without limitation, a pictorial icon of first set of pictorial icons 204 may include a checkpoint icon, such as a flag, which may be generated through apparatus 100 as a representation of a goal determined from user data 104. A checkpoint icon may have a symbolic category of “custom missions”. Continuing this example, a pictorial icon of first set of pictorial icons 204 may include an icon of an archery target, which may have a symbolic category of “gigs.” A pictorial icon of first set of pictorial icons 204 may include an icon of a hand holding a moneybag, which may have a symbolic category of “extra pay.”

Still referring to FIG. 2, in some embodiments, each icon of first set of pictorial icons 204 may be connected through first flow channel graphic 208. First flow channel graphic 208 may include a tube-like illustration. In some embodiments, first flow channel graphic 208 may include a multi-pronged display. First flow channel graphic 208 may include, but is not limited to, a tube-like illustration having a three-prong proximal end on a top side and a single prong end on a bottom side. In some embodiments, first flow channel graphic 208 may include one or more colors such as, but not limited to, white, grey, green, blue, and the like. First flow channel graphic 208 may include a connection on a prong end to collective data icon 212. A “collective data icon” as used in this disclosure is a graphical depiction of a summate value. In some embodiments, GUI 124 may display a plurality of collective data icons 212. Collective data icon 212 may include a shape, such as, but not limited to, circular, triangular, hexagonal, rectangular, square, and the like. In some embodiments, collective data icon 212 may display a summate value, such as a total amount of points, tokens, currency, and the like. Collective data icon 212 may be positioned below first set of pictorial icons 204 and above second set of pictorial icons 216, without limitation.

Still referring to FIG. 2, in some embodiments, GUI 124 may display second flow channel graphic 220. Second flow channel graphic 220 may include a tube-like illustration. In some embodiments, second flow channel graphic 220 may include one or more prongs. In some embodiments, second flow channel graphic 220 may include three prongs on a bottom side and one prong on a first side, without limitation. Second flow channel graphic 220, and/or other elements of GUI 124, may include an orientation. An “orientation” as used in this disclosure is a position relative to a point of reference. Orientation may include, without limitation, left, right, up, down, horizontal, vertical, inverted, mirrored, and the like. Second flow channel graphic 220 may include an orientation of upright, downright, inverted, flipped, and the like. In some embodiments, second flow channel 220 may include an orientation relative to first flow channel graphic 208. Second flow channel graphic 220 may include an orientation of inverted relative to first slow channel graphic 208. For instance and without limitation, first flow channel graphic 208 may include three prongs on a top side and a single prong on a bottom side. Second flow channel graphic 220 may mirror first flow channel graphic 208 across an x-axis, y-axis, and the like. In some embodiments, first flow channel graphic 208 and second flow channel graphic 220 may be oriented opposite collective data icon 212. As a non-limiting example, a single prong of first flow channel graphic 208 and a single prong of second flow channel graphic 220 may both connect to collective data icon 212 at opposite ends of collective data icon 212.

Still referring to FIG. 2, in some embodiments, GUI 124 may display second set of pictorial icons 216. Second set of pictorial icons 216 may include one or more graphic elements. Second set of pictorial icons 216 may include three graphic elements. In some embodiments, an icon of second set of pictorial icons 216 may include an allocation box. An allocation box may include, without limitation, folders icons, piggy bank icons, arrow graphics, pots, and the like. An allocation box may include a category, such as, but not limited to, a distribution category. A “distribution category” as used in this disclosure is a classification of one or more elements by dispersion. In some embodiments, a distribution category of an allocation box may include categories such as, but not limited to, spending, saving, sharing, and the like. In some embodiments, GUI 124 may display one or more text boxes adjacent and/or inside of one or more icons of second set of pictorial icons 216. A text box may display one or more characters, words, strings, and the like. For instance and without limitation, a text box may display the word “SHARE”, “SPEND”, “SAVE”, and the like thereof. In some embodiments, each pictorial icon of first set of pictorial icons 204 and/or second set of pictorial icons 216 may include a text box. In some embodiments, GUI 124 may display one or more allocation boxes adjacent to an icon of second set of pictorial icons 216. An allocation box may include a text box showing a percentage of a cumulative value displayed in collective data icon 212. A “cumulative value” as used throughout this disclosure is a total metric one or more elements. For instance and without limitation, an allocation box may display “50%”, “40%”, “30%”, and the like. In some embodiments, GUI 124 may display each icon of second set of pictorial icons 216 in a hierarchal order based on one or more values of one or more allocation boxes. For instance and without limitation, a first icon having a highest allocation box value may of second set of pictorial icons 216 may be displayed on a left side of second set of pictorial icons 216, and other icons may be displayed on a right side of the first icon in a descending order of value associated with their corresponding allocation boxes. In other embodiments, each icon of second set of pictorial icons 216 may be displayed in a grouping unrelated to allocation box values. For instance and without limitation, a first icon of second set of pictorial icons 216 may have a lower allocation box value than a second icon of second set of pictorial icons 216, and may be displayed on a leftmost portion of second set of pictorial icons 216. Values displayed on GUI 124 may be calculated through apparatus 100 as described above with reference to FIG. 1.

Still referring to FIG. 2, in some embodiments, GUI 124 may display interactive icon 224. An “interactive icon” as used in this disclosure is a graphic element having an event handler programmed to react to user input. Interactive icon 224 may include, but is not limited to, graphics of arrows, strings, buttons, and the like. In some embodiments, interactive icon 224 may include a graphic depiction of a lever. Interactive icon 224 may display, without limitation, a lever mechanism surrounded by a border. A “lever mechanism” as used throughout this disclosure is a slidable icon representative of a handle-like device. A lever mechanism may include, but is not limited to, buttons, cranks, triggers, plungers, valves, and the like. A lever mechanism may include a bar having a horizontal orientation positioned atop a set of slot holes. A user may interact with one or more portions of a lever mechanism of interactive icon 224. For instance and without limitation, a user may swipe down on a horizontal bar of a lever mechanism, swipe up on the horizontal bar, tap the horizontal bar, and/or other interactions with the lever mechanism. A border may include, without limitation, a rectangular shape, circular shape, triangular shape, hexagonal shape, and the like. A border of interactive icon 224 may include a color such as, but not limited to, yellow, green, red, blue, and the like. In some embodiments, interactive icon 224 may include an animated border. An animated border may include an animation such as, but not limited to, a rotating border, flashing border, and the like. In some embodiments, a border of interactive icon 224 may be animated to move in a clock-wise direction, counter clock-wise direction, and the like. GUI 124 may display interactive icon 224 adjacent to collective data icon 212. Interactive data icon 224 may be positioned on a side of collective data icon 212, such as, without limitation, a left side, right side, and the like. GUI 124 may display a text box adjacent to interactive icon 224. A text box adjacent to interactive icon 224 may include one or more words, characters, and/or phrases. For instance and without limitation, a text box adjacent to interactive icon 224 may display the word “Pull.” Interactive icon 224 may include graphical elements, such as, but not limited to, arrows, dollar signs, and the like. In some embodiments, interactive icon 224 may include two or more downward pointing arrows and a dollar sign positioned above the two or more downward pointing arrows. Each arrow of one or more downward pointing arrows of interactive icon 224 may be displayed in a descending order of transparency. A descending order of transparency may include, without limitation, a first downward pointing arrow having a highest transparency, a second downward pointing arrow having an average transparency, and/or a third downward pointing arrow having a lowest transparency, such as an opaque level of transparency. In some embodiments, each arrow of one or more downward pointing arrows of interactive icon 224 may include a descending order of thickness. A descending order of thickness may include, without limitation, a first downward pointing arrow having a smallest line width, a second downward pointing arrow having an average line width, and/or a third downward pointing arrow having a highest line width.

Still referring to FIG. 2, in some embodiments, GUI 124 may display token icon 228. Token icon 228 may include a depiction of a coin, such as, without limitation, an arcade token. In some embodiments, GUI 124 may display one or more token icons 228. GUI 124 may display token icon 228 underneath one or more icons of first set of pictorial icons 208 and/or second set of pictorial icons 216.

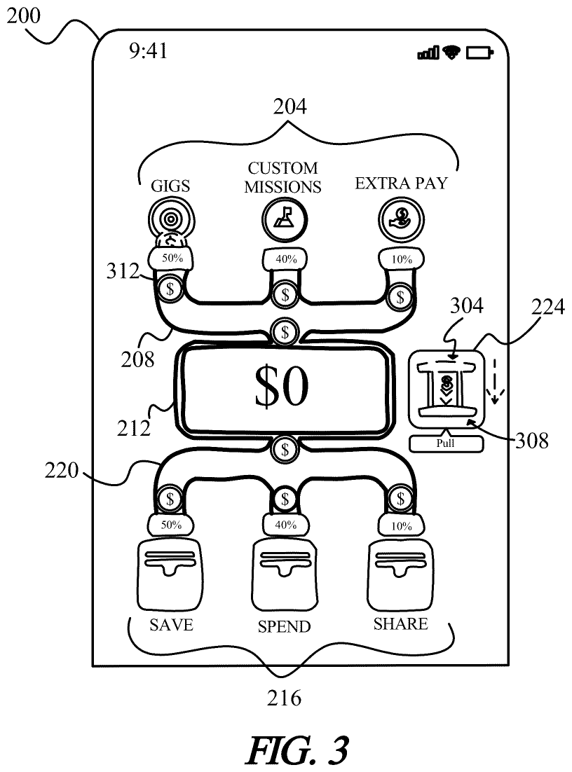

Referring now to FIG. 3, a depiction of an interaction with GUI 124 is illustrated. GUI 124 may display interactive icon 224. Interactive icon 224 may be as described above with reference to FIG. 2. GUI 124 may display an element of interactive icon 224 in first position 304. First position 304 may include a position within GUI 124, such as, without limitation, within a border of interactive element 224. An element of interactive icon 224 may include a lever, bar, and the like, without limitation. In some embodiments, an event handler of interactive icon 224 may be configured to respond to user input. User input may include, without limitation, taps, swipes, and the like. In some embodiments, an event handler of interactive icon 224 may be programmed to determine a swiping input received through a touch screen that may display GUI 124. An event handler of interactive icon 224 may respond to user input through animating interactive icon 224 from a first position 304 to second position 308. Second position 308 may include a position differing from first position 304. In some embodiments, second position 308 may include a position on a bottom part of a border of interactive icon 224. Second position 308 may include a position mirroring that of first position 304. In some embodiments, GUI 124 may animate a bar of interactive icon 224 from first position 304 to second position 308.

Still referring to FIG. 3, in some embodiments, GUI 124 may animate flow graphic 312. A “flow graphic” as used in this disclosure is an illustrative icon representative of a movement. Flow graphic 312 may include one or graphic depictions, such as, without limitation, fluids, currency depictions, and the like. GUI 124 may display an animation of a plurality of token icons 228 from first set of pictorial icons 204 to second set of pictorial icons 216. A quantity of token icons 228 may be generated based on a value of each icon of first set of pictorial icons 204. In some embodiments, flow graphic 312 may include token icon 228 as described above with reference to FIG. 2. GUI 124 may animate flow graphic 312 from one or more icons of first set of icons 204 to collective data icon 212 through first flow channel graphic 208. Animation may include moving one or more flow graphics 312 through one or more channels of first flow channel graphic 208. In some embodiments, an event handler of GUI 124 may be programmed to animate flow graphic 312 as a function of a movement of an element of interactive icon 224 from first position 304 to second position 308. For instance and without limitation, an element of interactive icon 224 may move from first position 304 to second position 308, which may trigger an animation of flow graphic 312 from one or more icons of first set of pictorial icons 204 through first flow channel graphic 208 to collective data icon 212. Collective data icon 212 may be animated to show an increase of one or more values. For instance and without limitation, collective data icon 212 may display an animation of numerical digits in a scrolling animation, such as a first numerical digit moving downwards from a first position while decreasing in size, while a second numerical digit scrolls from a top position to a middle position while increasing in size. A scrolling animation may animate numerical digits in a “slot machine” fashion. In some embodiments, collective data icon 212 may animate an increase in value of numerical digits with a “pop” effect. A “pop” effect may include a rapid change in size of one or more numerical digits. For instance and without limitation, a “pop” effect may animate a numerical digit increasing in size rapidly, following a rapid decrease in size. In some embodiments, collective data icon 212 may display one or more colors of a summate value, such as, without limitation, red, green, blue, turquoise, yellow, orange, and the like. Collective data icon 212 may display an animation of a color change of a summate value, which may correspond to an increase and/or decrease of value of a summate value. As a non-limiting example, collective data icon 212 may display a first summate value having a green color, such as “$20.00”. Collective data icon 212 may display a second summate value having a red color, such as “15.00”, which may be representative of a decrease in value of the second summate value. In some embodiments, GUI 124 may animate a difference in summate values. An animation of a difference in summate values may include displaying one or more numerical digits and fading away the numerical digits over a period of time. For instance and without limitation, in the above example, GUI 124 may display a “$5.00” text box having a red color on a side of collective data icon 212, within collective data icon 212, and the like. GUI 124 may display an animation of a red “$5.00” text box decreasing in transparency, which may include a “fading” animation. In some embodiments, GUI 124 may animate a difference in summate values from a first position near and/or within collective data icon 212 to a second position away from collective data icon 212. For instance and without limitation, GUI 124 may animate a text box of “$5.00” moving from a first position adjacent to collective data icon 212 to a second position further away from collective data icon 212.

Still referring to FIG. 3, in some embodiments, GUI 124 may display and animate one or more flow graphics 312 as a function of a value associated with each icon of first set of pictorial icons 204. For instance and without limitation, a value associated with a first icon of first set of pictorial icons 204 may be greater than the rest of the icons of first set of pictorial icons 204. GUI 124 may animate a greater quantity of flow graphics 312 from a first icon of first set of pictorial icons 204 based on a higher value of the first icon of first set of pictorial icons 204. In other embodiments, an equal amount of flow graphics 312 may be animated from each icon of first set of pictorial icons 204. GUI 124 may animate collective data icon 212 based on a movement of an element of interactive icon 224 from first position 304 to second position 308. As a non-limiting example, a user may swipe down on a bar of interactive icon 224, causing an animation of the bar from first position 304 to second position 308. GUI 124 may animate an updating of a value of collective data icon 212 based on an animation of interactive icon 224. In some embodiments, GUI 124 may animate collective data icon 212 based on flow graphic 312 moving from an icon of first set of pictorial icons 204 to collective data icon 212. In some embodiments, an animation of one or more flow graphics 312 may correspond to one or more user patterns 116 as described above with reference to FIG. 1, without limitation.

Still referring to FIG. 3, collective data icon 212 may be animated concurrently with an animation of flow graphic 312. In other embodiments, collective data icon 212 may be animated to update a cumulative value once one or more flow graphics 312 reach a border of collective data icon 212. As a non-limiting example, flow graphic 312 may be animated from first set of pictorial icons 204 to collective data icon 212, where each flow graphic 312 may be animated to disappear into collective data icon 212. Disappearing may include removing one or more portions of flow graphic 312 as the one or more portions contact a border of collective data icon 212. In other embodiments, GUI 124 may animate flow graphic 312 to pass through collective data icon. For instance and without limitation, flow graphic 312 may be animated from an icon of first set of pictorial icons 204 to collective data icon 212. Flow graphic 312 may be displayed in collective data icon 212. In some embodiments, collective data icon 212 may display a pile and/or stash of two or more flow graphics 312. A pile and/or stash may include a plurality of flow graphics 312 overlapping on a bottom border of collective data icon 212. In some embodiments, GUI 124 may display flow graphic 312 moving with realistic physics, such as, but not limited to, falling, rolling, accelerating, and the like. In other embodiments, GUI 124 may display flow graphic 312 moving at a constant speed and equidistant from borders of other icons of GUI 124, and the like.

Still referring to FIG. 3, in some embodiments, GUI 124 may animate flow graphic 312 from collective data icon 212 to one or more icons of second set of pictorial icons 216. Animating flow graphic 312 may include animating a plurality of token icons 228 from collective data icon 212 to second set of pictorial icons 216. A quantity of token icons 228 of a plurality of token icons 228 of flow graphic 312 may be generated based on a value of each icon of second set of pictorial icons 216. GUI 124 may disperse one or more flow graphics 312 to one or more prongs of second fluid channel graphic 220. For instance and without limitation, 5 flow graphics 312 may move to a first icon of second set of pictorial icons 216, 4 flow graphics 312 may move to a second icon of second set of pictorial icons 216, and a single flow graphic 312 may move to a third icon of second set of pictorial icons 216. In some embodiments, a distribution of flow graphics to second set of pictorial icons 216 may be representative of values associated with each icon of second set of pictorial icons 216. For instance and without limitation, a first icon of second set of pictorial icons 216 may include a text box displaying “50%”, and 50% of flow graphics 312 animated from first fluid channel graphic 208 to collective data icon 212 may be animated to the first icon. In other embodiments, each icon of second set of pictorial icons 216 may receive equal quantities of flow graphics 312. In some embodiments, GUI 124 may animate a movement of flow graphics 312 through first fluidic channel graphic 208 at a first speed and an animation of flow graphics 312 through second fluidic channel graphic 220 at a second speed. In some embodiments, a first speed and a second speed may include an equal movement rate. In other embodiments, a first speed may include a speed faster than that of a second speed, and vice versa. A speed of an animation of flow graphics 312 may be based on one or more values of one or more allocation boxes of second set of pictorial icons 216. For instance and without limitation, a first icon of second set of pictorial icons 216 may include an allocation box including a value of “50%”, a second icon including an allocation box having a value of “40%”, and a third icon having an allocation box having a value of “10%”. A quantity and/or speed of an animation of flow graphics 312 from collective data icon 212 may be determined as a function of these values. For instance and without limitation, a large quantity of flow graphics 312 may be animated faster to a first icon of second set of pictorial icons 216 than a quantity of flow graphics 312 may be animated to a second icon and/or third icon of second set of pictorial icons 216. In some embodiments, a larger value of an allocation box may correspond to a larger quantity of flow graphics 312. In some embodiments, a larger value of an allocation box may correspond to a faster animation of one or more flow graphics 312. In other embodiments, a larger value of an allocation box may correspond to a slower animation of one or more flow graphics 312. In some embodiments, GUI 124 may animate one or more icons of second set of pictorial icons 216 with a “pop” effect based on one or more flow graphics 312 reaching a border of an icon of second set of pictorial graphics 216. In some embodiments, a text box of each icon of second set of pictorial icons 216 may be animated to update a distribution percentage concurrently with receiving one or more flow graphics 312. In other embodiments, one or more text boxes of one or more icons of second set of pictorial icons 216 may be updated based on an animation of interactive icon 224. For instance and without limitation, text boxes of second set of pictorial icons 216 may updated distribution percentages of one or more allocation categories based on an animation of interactive icon 224.

Continuing to refer to FIG. 3, in some embodiments, one or more graphics 312 may animate to collective data icon 212 through first set of fluidic channel graphic 208 as a function of an animation of interactive icon 224. Interactive icon 224 may transition from second position 308 to first position 304 concurrently with an animation of one or more flow graphics 312. An event handler of interactive icon 224 may be responsive to a second user input, such as, without limitation, swiping, taps, long presses, clicking, and the like. A second user input of interactive icon 224 may trigger a second animation of flow graphics 312. A second animation of flow graphics 312 may include an animation of flow graphics 312 from collective data icon to second set of pictorial icons 216 through second fluid channel graphic 220. In some embodiments, a second animation may include a movement of a plurality of flow graphics 312 dispersing from collective data icon 212 to one or more icons of second set of pictorial icons 216. Dispersing may include animating a plurality of flow graphics 312 from a top prong of second fluidic channel graphic 220 to one or more prongs of a bottom portion of second fluidic channel graphic 220. Dispersion of each flow graphic 312 to an icon of second set of pictorial icons 216 may be representative of a user pattern, such as user pattern 116. Dispersion of each flow graphic 312 to an icon of second set of pictorial icons 216 may be based on one or more categories, such as, without limitation, spending, saving, sharing, and the like. For instance and without limitation, 50% of a total sum of flow graphics 312 may animate to a first icon representing a category of “spending”, 40% of a total sum of flow graphics 312 may animate to a second icon representing a category of “saving”, and 10% of a total sum of flow graphics 312 may animate to a third icon representing a category of “sharing”. In some embodiments, a second animation may animate a dispersion of flow graphics 312 from collective data icon 212 to second set of pictorial icons 216 with an approximated amount of flow graphics 312 representative of an allotment value of each icon of second set of pictorial icons 216. An “approximated amount” as used in this disclosure is a quantity of icons visibly discernable from another quantity of icons. For instance and without limitation, a first group of flow graphics 312 may include a quantity greater than a second and/or third group of flow graphics 312, with each quantity generated separately from a total value of collective data icon 212 and/or allotment values of each icon of second set of pictorial icons 216. In some embodiments, a second animation of flow graphics 312 may animate a plurality of flow graphics 312 from collective data icon 312 to second set of pictorial icons 216 at a speed faster or slower than that of an animation of a plurality of flow graphics 312 from first set of pictorial icons 204 to collective data icon 212. In some embodiments, an animation of flow graphics 312 to second set of pictorial icons 216 may include an acceleration animation. An “acceleration animation” as used in this disclosure is a movement of one or more icons that increases in a magnitude of speed. For instance and without limitation, an acceleration animation of flow graphics 312 of a second animation may include one or more flow graphics 312 moving downward through second fluidic channel graphic 220 with a sharp acceleration nearing a prong of second fluidic channel graphic 220. In other embodiments, a second animation of one or more flow graphics 312 from collective data icon 212 to second set of pictorial icons 216 may include a sharp acceleration in a negative value, which may include a slowing movement speed of the one or more flow graphics 312 as they approach a prong of a bottom side of second fluidic channel graphic 220. A second animation of flow graphics 312 may include any animation of flow graphic 312 as described above. In some embodiments, a second animation of flow graphic 312 may include a movement of one or more flow graphics 312 having an animation different from an animation of one or more flow graphics 312 from first set of pictorial icons 204 to collective data icon 212. In other embodiments, a second animation may include an animation of flow graphics 312 from first set of pictorial icons 204 to collective data icon 212 as described above. In other embodiments, flow graphics 312 may animate from first set of pictorial icons 204 to second set of pictorial icons 216 in a single animation, without limitation.

Still referring to FIG. 3, in some embodiments, GUI 124 may display one or more text boxes when an animation of one or more flow graphics 312 is completed. For instance and without limitation, GUI 124 may display a text box including the phrase “Watch Again?”. GUI 124 may display another interactive icon alongside the phrase “Watch Again?”. An interactive icon may include a graphic such as, but not limited to, a button. A button may display a circular arrow, which may depict a “redo” function. GUI 124 may receive a third user input, which may include, but is not limited to, tapping, pressing, flicking, swiping, and the like, through a button of an interactive icon next to a text box including a phrase “Watch Again?”. Upon receiving a third user input, GUI 124 may reset all icons, values, and the like of GUI 124. GUI 124 may repeat this process indefinitely or until an exit flag is triggered. An exit flag may include, but is not limited to, cycles of animation, additional user input, and the like.

Referring now to FIG. 4, user database 400 is illustrated. User database 400 may be implemented, without limitation, as a relational database, a key-value retrieval database such as a NOSQL database, or any other format or structure for use as a database that a person skilled in the art would recognize as suitable upon review of the entirety of this disclosure. User database 400 may alternatively or additionally be implemented using a distributed data storage protocol and/or data structure, such as a distributed hash table or the like. User database 400 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

Still referring to FIG. 4, user database 400 may include user category data 404. User category data 404 may include one or more types of classifications of user data, such as, without limitation, user data 104. User category data 404 may include data of user categories such as, but not limited to, currency distributions, frequency of transferred currency, quantities of currency, and the like. Apparatus 100 may communicate with user database 400 to update user category data 404. In some embodiments, apparatus 100 may communicate with user database 400 to update one or more elements of GUI 124 as a function of user category data 404.

Still referring to FIG. 4, in some embodiments, user database 400 may include classification criteria data 408. Classification criteria data 408 may include data of one or more classification criteria, such as classification criterion 108 as described above with reference to FIG. 1. Classification criteria data 408 may include one or more values, ranges of values, and the like, that may represent thresholds for classification of user data 104. As a non-limiting example, classification criteria data 408 may include a value of “−$5” which may represent a currency amount that if reached classifies user data to a “spending” category. Apparatus 100 may communicate with user database 400 to update classification criteria data 408.

Still referring to FIG. 4, in some embodiments, user database 400 may include user pattern data 412. User pattern data 412 may include user patterns 116 as described above with reference to FIG. 1, without limitation. In some embodiments, user pattern data 412 may include patterns of currency distribution of user data, such as, without limitation, user data 104. Patterns may include, but are not limited to, most frequently earned income type, highest dispersion of income, saving of currency, and the like. Apparatus 100 may communicate with user database 400 to update user pattern data 412 and/or user pattern data 412 to generate one or more elements of GUI 124.

Still referring to FIG. 4, in some embodiments, user database 400 may include user profile data 416. User profile data 416 may include one or more profiles of one or more users. A profile may include a set of data representative of an individual. User profile data 416 may include, without limitation, geographical data, demographic data, currency types, finance account information, and the like. In some embodiments, user profile data 416 may include user pattern data 412. For instance and without limitation, a user profile of user profile data 416 may include currency distribution patterns of user pattern data 412. Apparatus 100 may communicate with user database 400 to update user profile data 416 and/or generate one or more elements of GUI 124 as a function of user profile data 416.

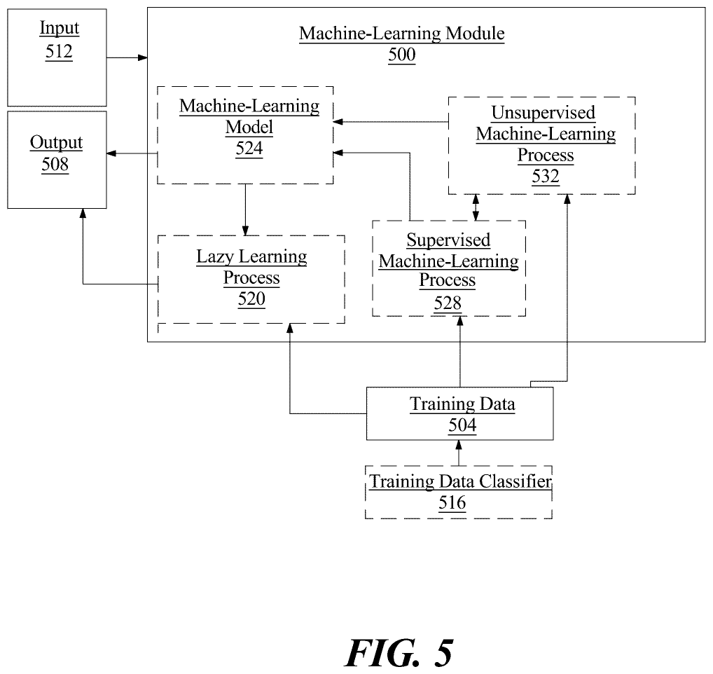

Referring now to FIG. 5, an exemplary embodiment of a machine-learning module 500 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 504 to generate an algorithm that will be performed by a computing device/module to produce outputs 508 given data provided as inputs 512; this is in contrast to a non-machine learning software program where the commands to be executed are determined in advance by a user and written in a programming language.

Still referring to FIG. 5, “training data,” as used herein, is data containing correlations that a machine-learning process may use to model relationships between two or more categories of data elements. For instance, and without limitation, training data 504 may include a plurality of data entries, each entry representing a set of data elements that were recorded, received, and/or generated together; data elements may be correlated by shared existence in a given data entry, by proximity in a given data entry, or the like. Multiple data entries in training data 504 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 504 according to various correlations; correlations may indicate causative and/or predictive links between categories of data elements, which may be modeled as relationships such as mathematical relationships by machine-learning processes as described in further detail below. Training data 504 may be formatted and/or organized by categories of data elements, for instance by associating data elements with one or more descriptors corresponding to categories of data elements. As a non-limiting example, training data 504 may include data entered in standardized forms by persons or processes, such that entry of a given data element in a given field in a form may be mapped to one or more descriptors of categories. Elements in training data 504 may be linked to descriptors of categories by tags, tokens, or other data elements; for instance, and without limitation, training data 504 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 5, training data 504 may include one or more elements that are not categorized; that is, training data 504 may not be formatted or contain descriptors for some elements of data. Machine-learning algorithms and/or other processes may sort training data 504 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 504 to be made applicable for two or more distinct machine-learning algorithms as described in further detail below. Training data 504 used by machine-learning module 500 may correlate any input data as described in this disclosure to any output data as described in this disclosure. As a non-limiting illustrative example inputs may include user data and outputs may include user patterns.

Further referring to FIG. 5, training data may be filtered, sorted, and/or selected using one or more supervised and/or unsupervised machine-learning processes and/or models as described in further detail below; such models may include without limitation a training data classifier 516. Training data classifier 516 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 500 may generate a classifier using a classification algorithm, defined as a processes whereby a computing device and/or any module and/or component operating thereon derives a classifier from training data 504. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 516 may classify elements of training data to user patterns such as currency distribution, frequent currency transfers, currency savings, and the like.

Still referring to FIG. 5, machine-learning module 500 may be configured to perform a lazy-learning process 520 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 504. Heuristic may include selecting some number of highest-ranking associations and/or training data 504 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 5, machine-learning processes as described in this disclosure may be used to generate machine-learning models 524. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 524 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 524 may be generated by creating an artificial neural network, such as a convolutional neural network comprising an input layer of nodes, one or more intermediate layers, and an output layer of nodes. Connections between nodes may be created via the process of “training” the network, in which elements from a training data 504 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 5, machine-learning algorithms may include at least a supervised machine-learning process 528. At least a supervised machine-learning process 528, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include user data as described above as inputs, user patterns as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 504. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

Further referring to FIG. 5, machine learning processes may include at least an unsupervised machine-learning processes 532. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 5, machine-learning module 500 may be designed and configured to create a machine-learning model 524 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 5, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

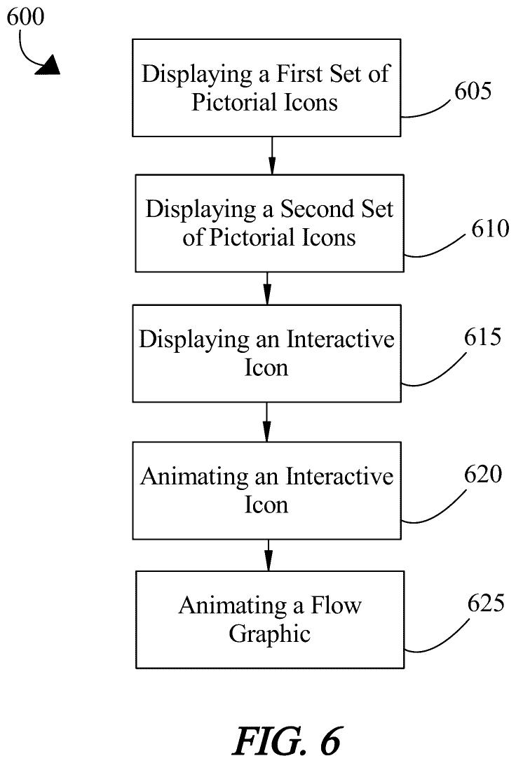

Referring now to FIG. 6, method 600 of animating user data is illustrated. At step 605, method 600 includes displaying a first set of pictorial icons. A first set of pictorial icons may include a symbolic category element. This step may be implemented as described above with reference to FIGS. 1-3, without limitation.

Still referring to FIG. 6, at step 610, method 600 includes displaying a second set of pictorial icons. In some embodiments, a second set of pictorial icons may include a distribution category. Each icon of a second set of pictorial icons may include an allocation box. In some embodiments, a collective data icon may be displayed. A collective data icon may be positioned below a first set of pictorial icons and above a second set of pictorial icons. In some embodiments, a collective data icon may be configured to display a cumulative value of a first set of pictorial icons. This step may be implemented as described above with reference to FIGS. 1-3, without limitation.

Still referring to FIG. 6, at step 615, method 600 includes displaying an interactive icon. An interactive icon may include, without limitation, a lever mechanism. This step may be implemented as described above with reference to FIGS. 1-3, without limitation.

Still referring to FIG. 6, at step 620, method 600 includes animating an interactive icon. Animating an interactive icon may include animating an element of the interactive icon from a first position to a second position. In some embodiments, animating an interactive icon may include animating a border of the interactive icon in a clock-wise or other direction. This step may be implemented as described above with reference to FIGS. 1-3, without limitation.

Still referring to FIG. 6, at step 625, method 600 includes animating a flow graphic. Animating a flow graphic may include animating a plurality of token icons from a collective data icon to a second set of pictorial icons. A quantity of tokens of a plurality of token icons may be generated based on a value of each icon of a second set of pictorial icons. In some embodiments, an animation of a flow graphic may correspond to user patterns. User patterns may be generated through a computing device. Generating user patterns through a computing device may include receiving user data from a user database and categorizing the user data to allotment categories as a function of a classification criterion. This step may be implemented as described above with reference to FIGS. 1-3, without limitation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

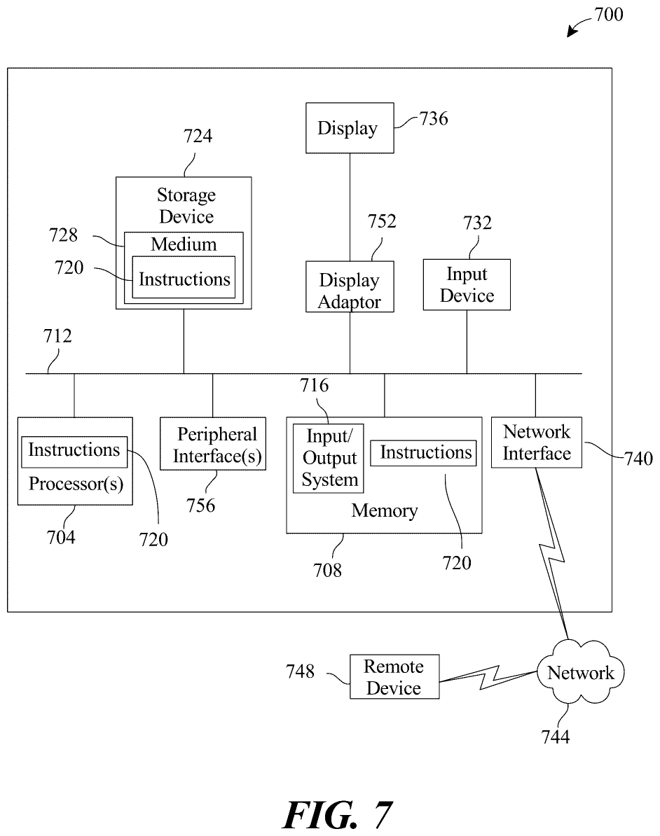

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Still referring to FIG. 7, processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Still referring to FIG. 7, memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Still referring to FIG. 7, computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Still referring to FIG. 7, computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

Still referring to FIG. 7, a user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Still referring to FIG. 7, computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for generating a graphical user interface (GUI) for animating user data, comprising:
at least a processor and a memory communicatively connected to the at least a processor, the memory containing instructions configuring the at least a processor to:
generate a graphical user interface comprising:
a first set of pictorial icons connected through a first flow channel graphic which includes a connection on a prong end to a collective data icon, wherein the collective data icon comprises animation of an increase in value of numerical digits with a pop effect, wherein each pictorial icon of the first set of pictorial icons includes a symbolic category, wherein the symbolic category is generated as a representation of a goal determines from user data;
a second set of pictorial icons, wherein each pictorial icon of the second set of pictorial icons includes a distribution category, and wherein a pictorial icon of the second set of pictorial icons comprises a value quantifier exchanged category; and
an interactive icon configured to receive user input, wherein upon receiving user input the GUI is configured to:
animate the interactive icon from a first position to a second position; and
animate a flow graphic from at least a first pictorial icon from the first set of pictorial icons to at least a second pictorial icon from the second set of pictorial icons.

2. The apparatus of claim 1, wherein the collective data icon is:
positioned below the first set of pictorial icons and above the second set of pictorial icons; and
configured to display a cumulative value of the first set of pictorial icons.

3. The apparatus of claim 2, wherein animating the flow graphic includes animating a plurality of token icons from the collective data icon to the second set of pictorial icons, wherein a quantity of token icons of the plurality of token icons is generated based on a value of each icon of the second set of pictorial icons.

4. The apparatus of claim 1, wherein the interactive icon includes a representation of a lever mechanism.

5. The apparatus of claim 1, wherein the animation of the flow graphic corresponds to a plurality of user patterns.

6. The apparatus of claim 5, wherein the plurality of user patterns is generated through the at least a processor, wherein the at least a processor is further configured to:
receive user data from a user database; and
categorize the user data to user categories as a function of a classification criterion.

7. The apparatus of claim 1, wherein each pictorial icon of the second set of pictorial icons includes an allocation box.

8. The apparatus of claim 1, wherein animating the flow graphic includes animating a plurality of token icons from the first set of pictorial icons to the second set of pictorial icons, and wherein a quantity of token icons of the plurality of token icons is generated based on a value of each icon of the first set of pictorial icons.

9. The apparatus of claim 1, wherein each pictorial icon of the first and second set of pictorial icons includes a text box.

10. The apparatus of claim 1, wherein a border of the interactive icon is animated to move in a clock-wise direction.

11. A method of animating user data comprising:
displaying, by a computing device, a first set of pictorial icons through a graphical user interface connected through a first flow channel graphic which includes a connection on a prong end to a collective data icon, wherein the collective data icon comprises animation of an increase in value of numerical digits with a pop effect, wherein each pictorial icon of the first set of pictorial icons includes a symbolic category element, wherein the symbolic category is generated as a representation of a goal determines from user data;
displaying, by the computing device, a second set of pictorial icons through the graphical user interface, wherein each pictorial icon of the second set of pictorial icons includes a distribution category, and wherein a pictorial icon of the second set of pictorial icons comprises a value quantifier exchanged category; and
displaying, by the computing device, an interactive icon configured to receive user input through the graphical user interface, wherein displaying the interactive icon further comprises:
animating the interactive icon from a first position to a second position; and
animating a flow graphic from at least a pictorial icon from the first set of pictorial icons to at least a pictorial icon from the second set of pictorial icons.

12. The method of claim 11, wherein the collective data icon is:
positioned below the first set of pictorial icons and above the second set of pictorial icons; and
configured to display a cumulative value of the first set of pictorial icons.

13. The method of claim 12, wherein animating the flow graphic includes animating a plurality of token icons from the collective data icon to the second set of pictorial icons, wherein a quantity of token icons of the plurality of token icons is generated based on a value of each icon of the second set of pictorial icons.

14. The method of claim 11, wherein the interactive icon includes a lever mechanism.

15. The method of claim 11, wherein the animation of the flow graphic corresponds to user patterns.

16. The method of claim 15, wherein the user patterns are generated through the computing device, wherein generating the user patterns comprises:
receiving, at the computing device, user data from a user database; and
categorizing, by the computing device, the user data to allotment categories as a function of a classification criterion.

17. The method of claim 11, wherein each pictorial icon of the second set of pictorial icons includes an allocation box.

18. The method of claim 11, wherein animating the flow graphic includes animating a plurality of token icons from the first set of pictorial icons to the second set of pictorial icons, wherein a quantity of token icons of the plurality of token icons is generated based on a value of each icon of the first set of pictorial icons.

19. The method of claim 11, wherein each pictorial icon of the first and second set of pictorial icons includes a text box element.

20. The method of claim 11, wherein a border of the interactive icon is animated to move in a clock-wise direction.
